(19) United States
(12) Patent Application Publication
(10) Pub. No.: US 2026/0200272 A1
(43) Pub. Date: Jul. 16, 2026

(54) Device for Attaching an Electronic Component to a Tire Casing

(71) Applicant: COMPAGNIE GENERALE DES ETABLISSEMENTS MICHELIN, Clermont-Ferrand (FR)

(72) Inventor: Loic BERLIOUX, Clermont-Ferrand Cedex 9 (FR)

(21) Appl. No.: 19/138,584

(22) PCT Filed: Nov. 20, 2023
(86) PCT No.: PCT/EP2023/082397

§ 371 Date: Jun. 12, 2025

(30) Foreign Application Priority Data
Dec. 14, 2022 (FR) FR2213311

(51) Int. Cl. B60C 19/00

(52) U.S. Cl. CPC B60C 19/00; B60C 2019/004

(57) ABSTRACT

An electronic system (1000) having a member (10) and a retaining device (510). The retaining device has a base (511), a retaining wall (512) extending from the base (511) as far as an edge (513) and defining an open volume (520) that accommodates the member (10). The volume (520) having an opening (516) delimited by the edge (513). The member (10) having a housing (12) circumscribed inside a cylinder (17) having an axis of revolution (15); and wherein the retaining wall has a projecting element (550) radially on the outside of the free edge (513), extending over a thickness (e) along the axis of revolution (15), and the housing (12) has a groove (51) defining a second volume (52) which is able to accommodate the projecting element (550) of the retaining wall (512).

### FIELD OF THE INVENTION

The present invention relates to devices for securing an electronic member to a tire casing with the aim of conveying identification information regarding the tire casing or physical parameters of the tire casing that are measured by the electronic member over the course of the life of the tire casing.

### TECHNOLOGICAL BACKGROUND

The development of electronic objects in tire casings makes it possible to make tire casings connectable and connected, and this stimulates the development of new services in order to optimize the use of the tire casing, for example. However, these electronic members sometimes have thermally and mechanically fragile components, and this requires the electronic member to be inserted after the tire casing has been manufactured. Thus, the insertion of a securing device as interface between the electronic member and the tire has emerged. These securing devices are generally elastic so as not to highly stress the tire casing, so as to follow the substantial deformations undergone by the tire casing over the course of its use and so as to damp the stresses transmitted to the electronic member. One of the most commonly used designs for the device is a patch having a base used for securing to the tire casing and provided with a wall that is closed on itself and extends from the base as far as an opening. The wall serves to hold or keep the electronic member in position within the device, the electronic member being mounted tightly inside the wall that deforms elastically. The opening allows the electronic member to be inserted into and extracted from the patch by virtue of the elasticity of the material of the wall.

Document WO2018/150141A1 illustrates a patch of this nature. Although this patch specifically has a clamping system in order to limit the opening, it is in all respects in accordance with a patch for securing an electronic object to a tire casing. This type of patch sometimes exhibits a problem with the mechanical strength of the system comprising the patch and the electronic member over the course of the use of the tire casing to which this system is secured. Under high running speed conditions in particular, the forces generated on the patch and on the electronic member as a result of the change in radius of curvature at the moment when that angular sector of the tire casing to which the patch is secured enters or leaves the contact patch are considerable. This sometimes leads to the securing patch being deformed to such an extent that the electronic member mounted inside the patch comes at least partially out of its accommodating cavity in the patch, this ultimately leading to the electronic member being ejected from the patch. This ejection of the electronic member, which is generally destructive to the electronic member, may also damage the very structure of the tire casing as a result of the electronic member being thrown against the walls of the tire, notably at high speed.

The aim of the following subjects of the invention is to solve the problems of the electronic member being ejected from the securing patch. The solutions should simultaneously be economical and reliable and not adversely affect the operation of the electronic member accommodated within the securing patch.

### DESCRIPTION OF THE INVENTION

The invention relates to an electronic system comprising an electronic member and a retaining device for retaining the electronic member and able to be secured to a wall of a tire casing, said retaining device comprising:
a base that is able to be secured to the wall of the tire casing via an external surface,
a closed retaining wall, which is able to retain said electronic member, extending from the base as far as a free edge and defining, with said base, an open volume;
said volume, which is able to accommodate at least a part of said electronic member, being defined by an internal surface of said base and by an internal surface of said retaining wall, and having an opening, delimited by the free edge of said retaining wall, which is able to deform for the insertion of said electronic member into said volume;
   said electronic member comprising a protective housing defining an outer surface circumscribed inside a cylinder of which the axis of revolution is perpendicular to the median plane of the external surface of the base of said retaining device and which is delimited by two parallel planes; and characterized in that the retaining wall comprises a projecting element radially on the outside of the free edge with respect to the axis of revolution and extending towards the volume of the retaining device over a thickness in the direction of the axis of revolution of the cylinder circumscribing the protective housing, in that the outer surface of the protective housing comprises a continuous and closed groove radially on the outside of the projection of the free edge of the retaining wall onto the outer surface along the direction of the axis of revolution of the cylinder circumscribing the protective housing and extending over an axial distance, in that the groove defines a second volume which is able to accommodate the projecting element and in that the projecting element extends over a radial distance comprised in the radial extent of the groove with respect to the axis of revolution.

Such a retaining device makes it possible to address the technical problem stated, since the radial extension of the retaining wall is equipped with a projecting element, thereby giving the radial extension a certain stiffness at the location of that projecting element, and as a result the deformation of the opening of the patch can be managed in energy terms in a way that means the electronic member cannot be ejected easily from the securing device. This projecting element not being situated at the free edge also contributes to retaining the electronic member since, before the projecting element can be removed from the groove, it is necessary to turn down the radial extension of the retaining wall between its free edge and the projecting element. Thus, the sizing of the radial extension also governs the size of the opening delimited by the free edge, thereby forcing the electronic member to remain inside the open volume. The presence and the size of the continuous groove on the protective housing of the electronic member also creates an immobilization zone between the electronic member and the retaining device, thereby forcing the electronic member to remain inside the open volume of the securing device. However, the electronic member can still be extracted using an external tool that enlarges the opening of the retaining wall beforehand by applying a uniform specific load to the entirety of the free edge in order to reduce the radial extension of the retaining wall and make it come out of the groove. During use of the tire and even at high speed, such a force cannot be applied to the system because the tool is not present in the tire and because the specific nature of the external force applied to the system at the moment of impact as the angular sector of the tire to which the electronic system is secured enters the contact patch is unable to be uniform over the entirety of the free edge of the retaining wall.

With preference, the projecting element of the retaining wall of the retaining device is annular around the axis of revolution and extends angularly over the entire projection of the free edge onto the external surface.

In order to take advantage of the mechanical anchoring provided by the continuous groove, it is preferable for the projecting element to angularly cover the axis of revolution of the electronic member in order to ensure the positioning of the electronic member within the retaining device. The angular coverage of the projecting element may be intermittent, i.e. the projecting element is made up of multiple disconnected pads at the same radial distance from the axis of revolution.

Very preferably, the cross section of the groove of the protective housing of the electronic member is the counterpart of the cross section of the projecting element of the retaining device.

By providing a synergy between the shapes of the cross section of the groove and the cross section of the projecting element, the contact surface area between the two elements is optimized, thereby increasing the overall contact force that can be applied for the same degree of deformation of the most elastic element, i.e. the projecting element.

Advantageously, the cross section of the projecting element is one of the following: a semicircle, half an ellipse, a quadrilateral.

These shapes have the advantage of offering a contact force that is non-linear, thereby making it possible to offer a contact-force gradient, which ensures better mechanical retention of the electronic member in the retaining device. Specifically, the retaining wall is less easy to deform than with a geometric shape that provides a linear progression, such as a triangle. In addition, these convex shapes make it possible to produce the projecting element on the retaining device and the groove on the protective housing economically, the shapes being obtainable by moulding, for example.

In one specific embodiment, the electronic member comprises the following elements:
a radio transmitter/receiver coupled to at least one radio antenna;
a microprocessor situated on the printed circuit, coupled to the radio transmitter/receiver and powered by an energy source,
   said elements being encapsulated in the protective housing.

The electronic member in this case comprises a radiofrequency transponder, i.e. comprises radiofrequency communications components able to transmit/receive so as to pick up a command and respond to this command. Here, the radiofrequency transponder is active, which is to say that it comprises an energy source that it uses chiefly for emitting the response by radiofrequency communication. This is because radiofrequency transmission is a functionality that consumes energy for a large-content responses such as, for example, transmitting measurement data, and the operations and calculations performed in a microprocessor may also make demands on energy. For the calculation functionality, the microprocessor has fairly sophisticated calculation capability in order to process the measurement data coming from a measurement sensor for example connected to the microprocessor. It should be noted that the energy source, which may for example be a battery, may be not only bulky but also heavy, leading to significant centrifugal forces and impact forces that are not insignificant if the electronic member is accidentally ejected from the securing device.

According to a particular embodiment, the distance of the groove is greater than half the thickness of the projecting element, preferably the distance is greater than the thickness of the projecting element.

With preference, the groove extends along the direction of the axis of revolution of the cylinder circumscribing the protective housing over a distance identical to the thickness of the projecting element along this direction.

Specifically, since the groove is first to come into contact with the projecting element as a result of their geographical proximity and is able to accommodate the projecting element inside the second volume, there will be a strong interaction between the two initially non-touching elements and this will improve the mechanical strength of the whole. Of course, the larger the contact surface area between the two elements is, the greater the force resulting from this contact is for the same degree of deformation applied. As a result, a greater amount of deformation energy will be required in order for the electronic member to be ejected from the retaining device. If the axial distance of the groove is at least half the thickness of the projecting element, the mechanical anchoring created by the interaction between the two components is enough to retain the electronic member within the retaining device. When the groove is deeper than the thickness of the projecting element, the projecting element is not compressed and the volume of the groove is axially sufficient to accommodate the projecting element without placing it under stress, thereby improving the mechanical retention of the projecting element. The ideal intermediate case is when the axial distance of the groove corresponds to the thickness of the projecting element. This is because the mechanical anchoring between the two components is at its greatest over the entire thickness of the projecting element and at the same time the preloading of the projecting element is minimized.

The mechanical immobilization between the projecting element and the groove is controlled by the depth of the groove. The greater the depth is, the greater the mechanical anchoring force of the retaining wall in the groove of the electronic member is. The mechanical strength of this anchoring has a threshold controlled by the thickness of the projecting element present in the groove along the direction of the axis of revolution of the cylinder circumscribing the protective housing. Ensuring that the depth of the groove is at least half the thickness of the projecting element provides additional deformation energy for extracting the electronic member that is sufficient to improve the mechanical strength of the electronic system.

According to a preferred embodiment, the projecting element of the retaining wall of the retaining device is continuous and closed.

The groove being continuous and annular means that the contact surface area between the projecting element and the groove is increased and the dimensions of the projecting element match the curvilinear length of the groove. This continuous shape of the projecting element improves the mechanical anchoring between the projecting element and the groove by increasing the contact surface area between the two and distributing the deformation energy over a larger surface area, while still ensuring that the stresses are continuous. This ensures a better mechanical retention of the projecting element, and this promotes running at high speeds and makes it possible to lengthen the service life of the electronic system before the electronic member is ejected from the retaining device by localized breakage of part of the projecting element, which could happen if the projecting element is intermittent piecewise. In addition, the axisymmetry of the projecting element means that the electronic system can be positioned freely within an object like a tire casing as regards the risk of the electronic member being ejected.

The invention also relates to an arrangement of an electronic system and of a tire casing able to rotate about an axis of rotation, said tire casing comprising a crown (S), two sidewalls (F) extending from the crown (S) and terminating in two beads (B) that are able to be connected to a wheel, wherein the electronic system is secured by means of the external surface of the base of the retaining device to one of the surfaces of the tire casing, preferably to the radially inner surface of the tire casing.

Advantageously, the electronic system is secured to the radially inner surface of the tire casing and the axial position of the electronic system is comprised in the axial extent of the crown (S) of the tire casing.

This arrangement is the final destination of the electronic system that forms the first subject of the invention. Because the electronic system comprises an electronic member, this electronic member cannot be fitted to the tire casing at the green tire stage. This is because the electronic member would be unable to withstand the thermal and mechanical stresses associated with the method for manufacturing a tire casing. It is usually preferable to install the electronic system after the tire has been manufactured. As a result, this electronic system is positioned on one of the surfaces, which are by nature exterior surfaces, of the tire casing. As a preference, the electronic system is positioned on the radially interior surface of the tire casing in line with respect to the natural axis of rotation of the tire casing. Thus, the electronic member is protected, in conditions of use on a tire casing, by the rubbery structure of the tire casing, which improves the mechanical endurance of the electronic member. Positioning it in line with the crown makes it possible to have easy access to measured characteristics measured by means of a sensor of the electronic member that is associated with the contact patch, thereby enabling tire-use characteristics, such as the applied static load, the running speed, to be fed back.

With preference, with the tire casing being able to rotate about the axis of rotation in a main direction corresponding to a direction of travel, with respect to the ground, of a vehicle equipped with said arrangement travelling forwards, the centre of mass of the points of the projecting element of the retaining wall of the retaining device in an axial plane is positioned behind the axis of revolution of the cylinder circumscribing the protective housing of the electronic member in the direction of travel of the vehicle when the electronic system is entirely in an angular sector of the tire casing that is in contact with the ground.

In instances in which the tire is being used for forward travel, which may be at very high running speeds, positioning the projecting element of the retaining wall with respect to the axis of revolution of the cylinder circumscribing the protective housing ensures that contact between the projecting element and the groove will occur immediately on entering the contact patch, irrespective of the shape or the positioning of the projecting element. As a result, the reaction force exerted by this contact will oppose the ejection of the electronic member from the retaining device. Thus, the orientation of the electronic system in the tire casing when this system is positioned in line with the crown (S) of the tire casing is a factor that influences the non-ejection of the electronic member, particularly at very high speed. Running on a vehicle at high speed and very high speed occurs when the vehicle is in a forward gear travelling forwards.

What is meant here by the expression “behind” is that the two points are spaced by a distance d in said direction and that this distance d may be zero.

Very preferably, the median plane of the projecting element that delineates the angular sector of the projecting element into two equal angular sectors in the cylindrical frame of reference associated with the cylinder circumscribing the protective housing of the electronic member has a normal with a main component along the axis of rotation of the tire casing, this normal preferably being co-linear with the axis of rotation of the tire casing.

In order to ensure that the technical solution envisaged for retaining the electronic member in the securing device is effective in all types of condition of use on the vehicle, particularly when the tire casing is mounted on the steered axle of the vehicle, it is preferable for the projecting element to be angularly centred in such a way that contact is achieved equally well in a straight line as when cornering to the right or when cornering to the left.

### BRIEF DESCRIPTION OF THE DRAWINGS

The invention will be better understood upon reading the following description, given solely by way of non-limiting example and with reference to the appended figures, throughout which the same reference numerals denote identical parts, and in which:

FIG. 1 depicts a perspective view of an electronic member able to be secured to a tire via a retaining device, from the prior art;

FIG. 2 depicts a view in section on the radial plane of the electronic system according to the invention;

FIG. 3 depicts a view from above of the electronic system of the invention, i.e. from the same side as the opening of the cavity of the retaining device;

FIG. 4 depicts a perspective view, in cross section, of a tire casing equipped with an electronic system according to the invention.

### DETAILED DESCRIPTION OF EMBODIMENTS

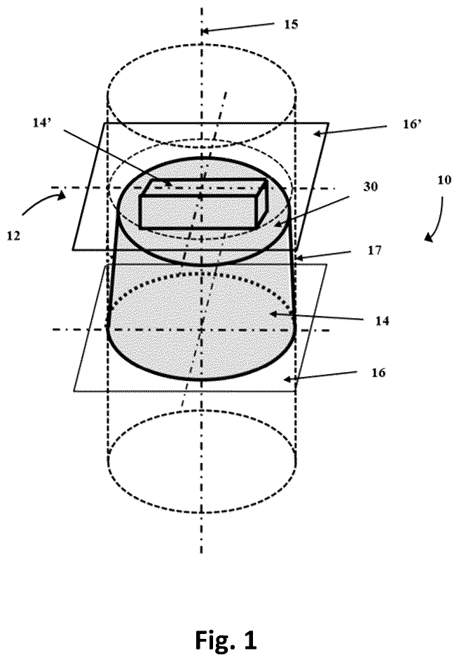

FIG. 1 is a perspective view of an electronic member 10 able to be secured to a tire casing using a retaining device, of the prior art.

The electronic member 10, depicted here in grey, is delimited by a protective housing 12 encapsulating all of the electronic components of the electronic member 10. This protective housing 12 has an exterior surface 30 circumscribed by a cylinder 17 having an axis of revolution 15 which is perpendicular to the printed circuit of the electronic member 10. This cylinder 17, which has an axis of revolution 15, is truncated by two parallel planes 16 and 16′ which rest respectively on the axially exterior surfaces 14 and 14′ of the protective housing 12.

This protective housing 12 takes the form of a combination of a cone and of a parallelepiped. The conical shape makes it easier to insert into or extract from a retaining device. On one of its axially exterior surfaces, the cone has a parallelpiped that houses the radio antenna. The latter is encapsulated in the protective housing 12. The protective housing 12 is a monolithic part or a part assembled from a number of component parts, the component parts then being welded together.

The component parts or the monolithic part are obtained for example using a moulding method from a plastics material such as a thermoset. Low-temperature curing of the plastic completes the production of the exterior surface 30 of the protective housing 12.

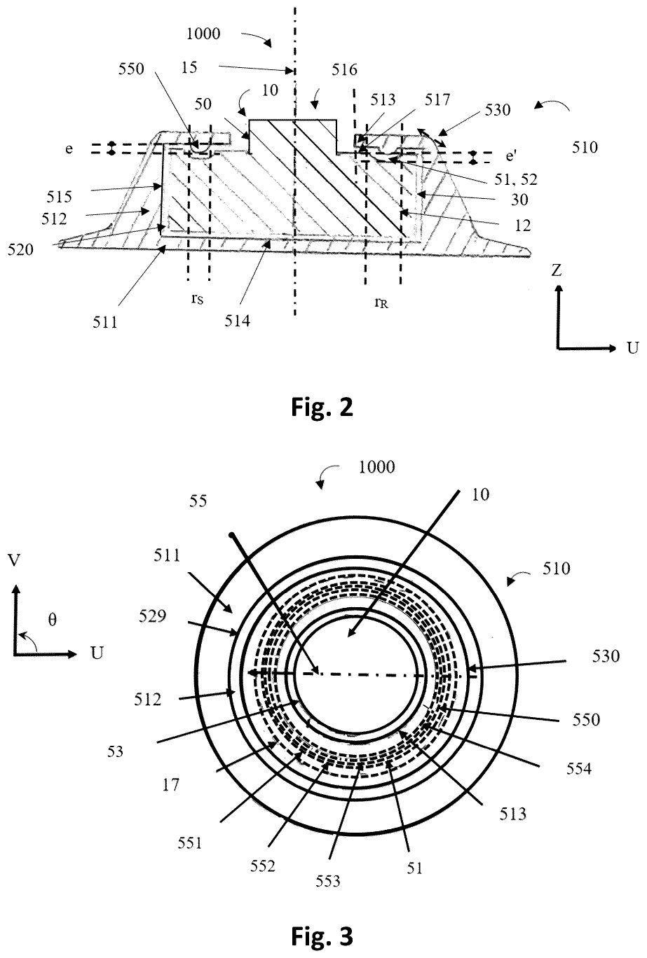

FIG. 2 is a view in section on the radial plane of an electronic system 1000 according to the invention.

The electronic system 1000 is made up of an electronic member 10 and of a retaining device 510 which is intended to be secured to the wall of a tire casing.

The retaining device 510 comprises a base 511 able to be secured to the wall of a tire casing via an external surface and a closed retaining wall 512, the purpose of which is to retain said electronic member 10. The retaining wall 512 extends from the base 511 as far as a free edge 513 and thus defines, with the base 511, a volume 520. In this case, a projecting element 550 is positioned on the retaining wall 512 in the direction of the volume 520. This element 550 takes the shape of a ring, which in this case is continuous and closed, around the axis of revolution 15 having a semicircular cross section. The height of this projecting element 550 is denoted “e” along the direction of the axis 15. This volume 520 is open, thus allowing the electronic member 10 to be inserted into and extracted from the volume 520. The volume 520 is defined by the internal surface 515 of the retaining wall 512 and the internal surface 514 of the base 511. The opening 516 of the volume 520 is delimited by the free edge 513 of the retaining wall 512. This opening 516 is able to deform to allow the electronic member 10 to be inserted into and extracted from the volume 520.

As in FIG. 1, the electronic member 10 comprises a protective housing 12 encapsulating all of the electronic components. This protective housing 12 defines an external surface 30. This external surface 30 is circumscribed inside a cylinder of which the axis of revolution 15 is perpendicular to the median plane of the external surface of the base 511. The circumscribing cylinder is truncated by two parallel planes the first of which belongs to the internal surface 514 of the base 511 and the second plane is situated axially to the outside of the opening 516 of the retaining device 510.

The retaining wall 512 extends axially from the base 511 as far as the free edge 513. That part of the retaining wall 512 that comprises the free edge 513 has an extension that is predominantly radial rather than axial so as to constitute a retaining lip for retaining the electronic member 10. One of the ends of the lip is the free edge 513. The other end 530 is a closed line, the points of which have a vector which is tangent to the retaining wall 512 and has a predominant component along the radial direction with respect to the axis of revolution 15 starting from the base 511. The radial extension of the lip thus formed extends from the closed line 530 as far as the free edge 513, comprises the projecting element 550 and contributes to retaining the electronic member 10 within the retaining device during high-speed running when the system 1000 is secured to the wall of a tire casing. Specifically, the projecting element 550, which is continuous or intermittent and extends angularly over the entirety of the free edge 513 of the retaining wall, means that more energy is required to deform this lip, and this contributes to the retention of the electronic member 10 within the retaining device 510. However, the application of a sustained and well-directed force allows the lip to be opened out so that the electronic member 10 can be extracted from and inserted into the retaining device 510. In particular, this force needs to be uniform over the entirety of the free edge 513, this being something that does not naturally occur as the angular sector of the tire casing bearing the electronic system enters or exits the contact patch during running.

Specifically, the protective housing 12 in this case has a cliff 50 extending to the outside of the volume 520 of the retaining device 510. This cliff 50 has its main component extending along the direction of the axis of revolution 15.

The external surface 30 of the protective housing 12 has a groove 51 situated at the projecting element 550. This groove 51 defines an annular recess of semicircular cross section about the axis of revolution 15 extending radially over a distance IR greater than the radial extension r_{S} of the projecting element 550. In addition, the groove 51 extends axially over a distance, denoted “e′”, greater than half the thickness “e” of the projecting element 550. This defines a second volume 52 which is able to accommodate the projecting element 550.

The combination of the size of the lip defined by the retaining wall 512 with its free edge 513 provided with a projecting element 550 and the size of the groove 51 in line with the projecting element 550 ensures that there will be no accidental ejection of the electronic member 10 from the retaining device 510 during normal use at high speeds when the electronic system 1000 is installed on a tire of a motor vehicle.

FIG. 3 is a view from above of the electronic system 1000 of FIG. 2. What that means to say is that from outside the electronic system 1000, the latter is observed, in the axial direction, from the same side as the opening of the volume of the retaining device 510.

Starting from the radial periphery of the electronic system 1000, what can be seen first of all is the axially outer edge of the base 511, which in this case is circular, although the outer edge of the base 511 could also be elliptical or quadrilateral. What can be seen next is a first circle 529 which corresponds to the separation between the base 511 and the retaining wall 512 and which is characterized by a change in curvature, and the material points on this circle 529 have a vector tangential to the base 511 and the main component of which becomes axial having been radial starting from the base 511. What can be seen next is a circle 530 corresponding to the closed line of the retaining wall 512 which represents one end of the annular lip of the retaining wall 512. This lip ends at a second circle 513 which represents the free edge of the retaining wall 512. Next, between the circles 530 and 513 there is a first circle 17 drawn in dotted line which corresponds to the radially exterior surface of the circle circumscribing the external surface of the protective housing 12 of the electronic member 10. Then, there are four circles 551 to 554 in dotted line going inwards towards the electronic member 10. The circles 551 and 554 radially delimit the groove 51, which is continuous and closed. The circles 552 and 553 delimit the projecting element 550, which is axially above the lip.

Through the opening delimited by the circle 513, here there may be seen a circle 53 which delimits the axial end of the cliff 50 of the protective housing 12 of the electronic member 10. As a result, this cliff 50 is predominantly axial. The projecting element 550 delimited by the circles 552 and 553 is annular and continuous. Here, the angular extension of the projecting element is divided into two angular sectors of 180 degrees each by the median plane 55 of which the normal is co-linear with the vector V. As an aid to understanding, this view from above is defined in an axial plane U, V of which the normal corresponds to the axis of revolution of the circumscribing cylinder 17. Once the electronic system 1000 has been secured to the wall of the tire casing, the local vector U of the electronic system of FIG. 3 should preferably correspond to the director vector of the circumferential direction of the cylindrical frame of reference associated with the tire about its natural axis of rotation. Thus, once mounted on the vehicle, the centre of mass of the points of the projecting element 550 of the retaining wall 512 in an axial plane is situated at the level of, and thus behind, the axis of revolution of the electronic system 1000 when the tire is running along a roadway with the vehicle in a forward gear for travelling forwards. This then ensures more effective retention of the electronic member 10 within the retaining device 510.

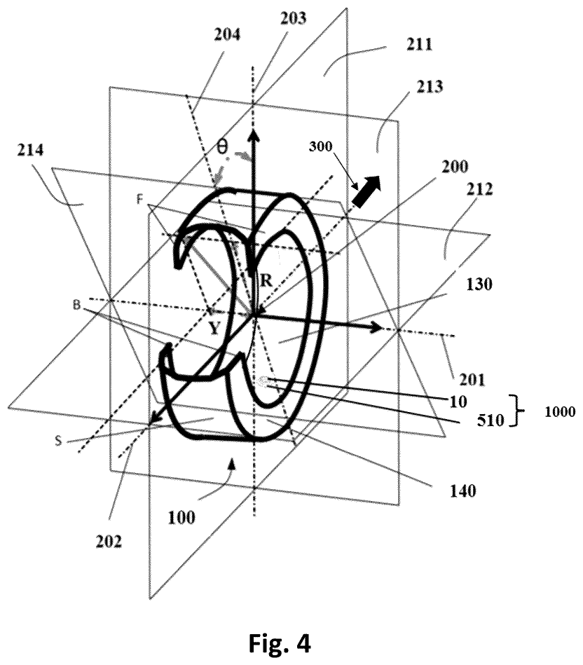

FIG. 4 shows a cross section of a pneumatic tire 100, which is also a tire casing, according to the invention, comprising a crown S extended by two sidewalls F and terminating in two beads B. In this case, the tire 100 is intended to be mounted on a wheel that is not shown in this figure, at the two beads B. A closed cavity containing at least one pressurized fluid is thus delimited, which is delimited both by the second, radially inner surface 130 of the pneumatic tire 100 and by the external surface of the wheel. The pneumatic tire 100 also comprises a first, radially external surface 140 of the pneumatic tire 100.

The axis corresponding to the reference axis or natural axis of rotation of the pneumatic tire 100, and the median plane 211, which is perpendicular to the reference axis 201 and equidistant from the two beads B, will be denoted the reference axis 201. The intersection of the reference axis 201 with the median plane 211 determines the centre of the pneumatic tire 100. A Cartesian frame of reference will be defined at the centre of the pneumatic tire 100, constituted of the reference axis 201, a vertical axis 203 perpendicular to the ground and a longitudinal axis 202 perpendicular to the other two axes. Furthermore, the plane that passes through the reference axis 201 and the longitudinal axis 202, parallel to the plane of the ground and perpendicular to the median plane 211, will be defined as the axial plane 212. Finally, the plane perpendicular to both the median plane 211 and the axial plane 212, passing through the vertical axis 203, will be termed the vertical plane 213.

Any material point of the pneumatic tire 100 is uniquely defined by its cylindrical coordinates (Y, R, θ). The scalar Y represents the axial distance to the centre of the pneumatic tire 100 in the direction of the reference axis 201, defined by the orthogonal projection of the material point of the tire 100 onto the reference axis 201. A plane making an angle θ with respect to the vertical plane 213 around the reference axis 201 will be defined as a radial plane 214. The material point of the pneumatic tire 100 is referenced in this radial plane 214 by the distance R to the centre of the pneumatic tire 100 in the direction perpendicular to the reference axis 201, identified by the orthogonal projection of this material point onto the radial axis 204. The unit vector perpendicular to the radial plane 214, which forms a direct trihedron with the unit vectors of the axial direction 201 and radial direction 204, represents the circumferential direction of the tire casing 100. It will be noted that FIG. 4 includes an arrow 300 which is assigned to the longitudinal axis 202 and indicates the direction of travel of the pneumatic tire 100 when it is mounted on the vehicle and the vehicle is travelling forwards.

This pneumatic tire 100 has, on the radially inner surface 130, a retaining device 510 that is secured to the surface 130 by adhesive bonding according to the usual prior-art techniques when the retaining device 510 is made of elastomer material. The retaining device 510 is secured in line with the crown S of the tire casing 100, and this improves its endurance since the retaining device 510 thus positioned invites less concern during the operations of mounting the tire casing 100 on the wheel or removing it therefrom. Specifically, the retaining device 510 is situated in a region distant from the beads B of the tire casing 100. In this case, the retaining device 510 is equipped with an electronic member 10 within its open volume that constitutes a housing designed to receive the electronic member 10. As a result, the tire casing 100 is in this case ready to be mounted on a wheel so as to constitute a wheel-tire assembly. The electronic member 10 may deliver various functions, such as identifying certain components like the electronic member itself, the tire. However, the electronic member may also be equipped with a pressure and/or temperature sensor in order to evaluate the inflation pressure of the wheel-tire assembly. Finally, it may also be equipped with a sensor directly measuring the curvature of the tire casing such as an accelerometer or a flexometer making it possible to derive usual variables of the tire such as the angular speed, the distance covered, the static load applied. All of these variables make it possible to identify performance qualities of the tire casing such as its wear, its grip or intrinsic variables of the ground on which the tire casing is running.

In the specific case of FIG. 4, the electronic components of the electronic member 10 are encapsulated in a protective housing. This protective housing has an annular groove which extends below the projecting element of the retaining device 510. In this case, the projecting element is intermittent, in the form of a single projecting pad representing an angular sector of 120 degrees about the axis of revolution. The angular orientation of the electronic system 1000 is intended, on the one hand, to position the pad in such a way that it is first to enter the contact patch, i.e. that the centre of mass of the points of the projecting element in a radial plane is situated behind the axis of revolution of the electronic member 10. On the other hand, the median plane of this pad is positioned in the circumferential direction of the tire in order to optimize the contact occurring between the groove and the pad when the vehicle is turning right or left.

1. An electronic system comprising an electronic member and a retaining device for retaining the electronic member and able to be secured to a wall of the tire casing, said retaining device comprising:
a base that is able to be secured to the wall of the tire casing via an external surface,
a closed retaining wall, which is able to retain said electronic member, extending from the base as far as a free edge and defining, with said base, an open volume;
said volume, which is able to accommodate at least a part of said electronic member, being defined by an internal surface of said base and by an internal surface of said retaining wall, and having an opening, delimited by the free edge of said retaining wall, which is able to deform for the insertion of said electronic member into said volume;
said electronic member comprising a protective housing defining an outer surface circumscribed inside a cylinder of which the axis of revolution is perpendicular to the median plane of the external surface of the base of said retaining device and which is delimited by two parallel planes; and
wherein the retaining wall comprises a projecting element radially on the outside of the free edge with respect to the axis of revolution and extending towards the volume of the retaining device over a thickness (e) in the direction of the axis of revolution of the cylinder circumscribing the protective housing, wherein the outer surface of the protective housing comprises a continuous and closed groove radially on the outside of the projection of the free edge of the retaining wall onto the outer surface along the direction of the axis of revolution of the cylinder circumscribing the protective housing and extending over an axial distance (e′), wherein the groove defines a second volume which is able to accommodate the projecting element and wherein the projecting element extends over a radial distance (r_{S}) comprised in the radial extent (r_{R}) of the groove with respect to the axis of revolution.

2. The electronic system according to claim 1, wherein the projecting element of the retaining wall of the retaining device is annular around the axis of revolution and extends angularly over the entire projection of the free edge onto the external surface.

3. The electronic system according to claim 1, wherein the cross section of the groove of the protective housing of the electronic member is the counterpart of the cross section of the projecting element of the retaining device.

4. The electronic system according claim 1, wherein the cross section of the projecting element is one of the following: a semicircle, half an ellipse, a quadrilateral.

5. The electronic system according claim 1, wherein the electronic member comprises the following elements:
a radio transmitter/receiver coupled to at least one radio antenna;
a microprocessor situated on a printed circuit, coupled to the radio transmitter/receiver and powered by an energy source,
said elements being encapsulated in the protective housing.

6. The electronic system according to claim 1, wherein the distance (e′) of the groove is greater than half the thickness (e) of the projecting element.

7. The electronic system according to claim 6, wherein the groove extends along the direction of the axis of revolution of the cylinder circumscribing the protective housing over a distance (e′) identical to the thickness (e) of the projecting element (550) along this direction.

8. The electronic system according to claim 2, wherein the projecting element of the retaining wall of the retaining device is continuous and closed.

9. An arrangement of an electronic system according to claim 1, and of a tire casing able to rotate about an axis of rotation, said tire casing comprising a crown (S), two sidewalls (F) extending from the crown (S) and terminating in two beads (B) that are able to be connected to a wheel, wherein the electronic system is secured by means of the external surface of the base of the retaining device to one of the surfaces of the tire casing tire.

10. The arrangement according to claim 9, wherein the electronic system is secured to the radially inner surface of the tire casing and the axial position of the electronic system is comprised in the axial extent of the crown (S) of the tire casing.

11. The arrangement according to claim 10, wherein, with the tire casing being able to rotate about the axis of rotation in a main direction corresponding to a direction of travel, with respect to the ground, of a vehicle equipped with said arrangement travelling forwards, the centre of mass of the points of the projecting element of the retaining wall of the retaining device in an axial plane is positioned behind the axis of revolution of the cylinder circumscribing the protective housing of the electronic member in the direction of travel of the vehicle when the electronic system is entirely in an angular sector of the tire casing that is in contact with the ground.

12. The arrangement according to claim 11, wherein the median plane of the projecting element that delineates the angular sector of the projecting element into two equal angular sectors in the cylindrical frame of reference associated with the cylinder circumscribing the protective housing of the electronic member has a normal with a main component along the axis of rotation of the tire casing tire.

13. The electric system according to claim 6, wherein the distance (e′) is greater than the thickness (e) of the projecting element.

14. The arrangement according to claim 9, wherein the electronic system is secured by means of the external surface of the base of the retaining device to the radially inner surface of the tire casing.

15. the arrangement according to claim 12, wherein the normal is co-linear with the axis of rotation of the tire casing.
